(19) United States
(12) Patent Application Publication
(10) Pub. No.: US 2003/0093208 A1
(43) Pub. Date: May 15, 2003

(54) System and method for monitoring the cornering dynamics of a motor vehicle

(76) Inventors: Ulrich Hessmert, Schwieberdingen (DE); Jost Brachert, Ditzingen (DE); Thomas Sauter, Remseck (DE); Helmut Wandel, Markgroeningen (DE); Norbert Polzin, Zaberfeld (DE)

Correspondence Address: KENYON & KENYON, ONE BROADWAY, NEW YORK, NY, 10004, US

(21) Appl. No.: 10/220,543

(22) PCT Filed: Dec. 21, 2001
(86) PCT No.: PCT/DE01/04848

(30) Foreign Application Priority Data
Dec. 30, 2000 (DE) 10065773.7

(51) Int. Cl. G06F 7/00

(52) U.S. Cl. 701/72

(57) ABSTRACT

A system for monitoring the cornering behavior of a motor vehicle having at least one wheel (12) includes at least one sensor device (10) assigned to a wheel (12) which detects at least one wheel variable of the wheel (12) during cornering of the vehicle and outputs a signal (Si, Sa) representing the at least one wheel variable, and in addition includes an assessment device (14) which processes the at least one signal (Si, Sa), the assessment device (14) determining at least one cornering limit value according to the result of the processing. The sensor device (10) is a wheel-force sensor device (10) which detects at least one wheel-force component of the wheel (12) acting essentially between the road surface and the wheel contact zone. In addition, a corresponding method is described.

### FIELD OF THE INVENTION

The present invention relates to a system for monitoring the cornering behavior of a motor vehicle having at least one wheel. The system may include at least one sensor device assigned to a wheel which may detect at least one wheel variable of the wheel during cornering of the vehicle and may output a signal representing the at least one wheel variable. The system may also include an assessment device which may process the signal. The assessment device may determine at least one cornering limit value according to the result of the processing.

The present invention also relates to a method of monitoring the cornering behavior of a motor vehicle having at least one wheel. The method may include detecting at least one wheel variable of a wheel during cornering of the motor vehicle, processing the at least one wheel variable of the wheel, and determining at least one cornering limit value according to the result of the processing.

### BACKGROUND INFORMATION

Conventional systems and methods may improve the driving response of a vehicle during cornering. For example, a conventional drive regulating device for a vehicle having four wheels, may have one wheel speed sensor per wheel, a steering angle sensor and a longitudinal acceleration sensor. A reference speed approximate to the vehicle speed may be determined from the speed signals of the non-driven wheels. A coefficient of friction μ acting between the tire contact zone and the road surface may be computed from the longitudinal acceleration detected by the longitudinal acceleration sensor. The coefficient of friction computed in this manner and the reference speed may be used to calculate a limit steering angle based on a numerical value equation, which, if exceeded, may indicate that the driving state is threatening to become unstable with a high degree of probability. If the steering angle exceeds the limit steering angle with drive slip still present at the same time and with a reference speed higher than a threshold speed, then the reference speed may not be recalculated from the wheel angle sensors but rather maintained at its current value. An engine and/or a braking intervention of a traction control system may adjust the vehicle speed to approximately this speed.

In connection with the sensors provided, various tire manufacturers may plan the future introduction of ‘smart’ tires. In doing so, novel sensors and analysis circuits may be affixed directly to the tire. In addition, the use of such tires may permit additional functions such as, for example, the measurement of the torque occurring at the tire transverse and longitudinal to the direction of travel, the tire pressure or the tire temperature. In this connection, tires may be provided, for example, in which magnetized areas or strips having field lines, for example, proceeding in the circumferential direction, may be incorporated in each tire. The magnetization may be performed, for example, by sections in the same direction but with opposite orientation, i.e., alternating polarity. The magnetized strips may proceed in the vicinity of the rim flange and in the vicinity of the contact area. The sensors thus may rotate at wheel speed. Corresponding pickups may be affixed to the body at two or more different points in the direction of rotation and in addition have a different radial spacing from the axis of rotation. Therefore, an inner measurement signal and an outer measurement signal may be obtained. A rotation of the tire may then be recognized via the changing polarity of the measurement signal(s) in the circumferential direction. The wheel speed may be calculated from the rolling circumference and the change over time of the inner measurement signal and the outer measurement signal, for example.

In a similar manner, the arrangement of sensors in the wheel bearing has been described, wherein this arrangement may be setup in both the rotating part and the static part of the wheel bearing. For example, the sensors may be implemented as microsensors in the form of microswitch arrays. The sensors arranged on the movable part of the wheel bearing may measure, for example, forces and accelerations as well as the rotational speed of a wheel. This data may be compared with electronically stored basic patterns or with data of an identical or similar microsensor which may be affixed to the fixed part of the wheel bearing.

### SUMMARY OF THE INVENTION

The present invention may build on a conventional system in that the sensor device may be a wheel-force sensor device which detects at least one wheel-force component of the wheel acting generally between the road surface and the wheel contact zone. An example system according to the present invention may simplify the sensors used in the system such that only one type of sensor device may be sufficient in the simplest case, for example.

It may be sufficient merely to assign one sensor device to one wheel of the vehicle. If a wheel-force component or another wheel variable is detected at only one part of the vehicle wheels, the values of the wheels not detected may be inferred from the value thus obtained. For the sake of the accuracy of the detected cornering limit value, at least one sensor device may be assigned to a plurality of wheels, for example, to all wheels.

Wheel variables may be detected by a sensor device assigned directly to the relevant wheel and may be determined precisely. One or more cornering limit values may therefore be determined accurately from wheel variables detected in this manner using comparatively simple sensors.

A wheel lateral force acting generally orthogonally to the wheel circumferential direction in the wheel contact plane and/or a wheel circumferential force acting tangentially to the wheel contact zone in the wheel circumferential direction and/or a wheel contact force acting orthogonally to the wheel contact zone may be used as wheel-force components which may be obtained from the processing of the sensor signal of the sensor device. In addition, a wheel rotational speed of at least one wheel, of at least one driven and at least one non-driven wheel, for example, or of all wheels, may be determined for taking the vehicle speed into consideration in determining the at least one cornering limit value.

The cited wheel-force components may be determined so that the coefficient of friction acting between the wheel contact zone and the road surface may be inferred from the wheel-force components. The wheel lateral force may permit the most precise result; however, one or more additional wheel-force components may be used to increase the accuracy and/or to check the plausibility of the result obtained using the wheel lateral force.

By taking a longitudinal acceleration of the vehicle into consideration in determining the coefficient of friction, the coefficient of friction may be determined more accurately. This may apply in particular if the coefficient of friction has initially been determined only from the wheel lateral force since then the contribution of a force acting in or against the direction of travel to the total drive force actually acting in the wheel contact plane may be additionally taken into consideration.

The longitudinal acceleration of the vehicle may be inferred from the wheel circumferential force of each wheel since the wheel circumferential force may be a force which accelerates or decelerates the vehicle. The longitudinal acceleration of the vehicle may also be determined using one or more wheel rotational speeds, in particular, from their change over time. In addition, both the wheel circumferential force and the wheel rotational speed of one wheel, or for example, of a plurality of, or of all wheels in particular, may be used in combination to determine the longitudinal acceleration of the vehicle to check the other result in each case for plausibility or to improve the accuracy of the result.

An additional improvement in accuracy in determining the coefficient of friction utilized between tires or between the tire and the road surface may be obtained by taking into consideration a dynamic axle load displacement of the vehicle during cornering. The dynamic axle load displacement may be determined in a simple manner from the wheel contact force of at least one wheel on the inside of the curve and at least one wheel on the outside of the curve, such as, for example, from the wheel contact force of all wheels.

A number of system configurations may be possible for determining the at least one cornering limit value.

According to an example embodiment of the invention, the assessment device may assess, on the basis of sensor signals supplied to it, a driving state of the vehicle to determine if it is non-critical, i.e., stable, or critical, i.e., unstable. The system configuration may be kept simple if the assessment device uses at least one detected wheel-force component and/or wheel rotational speed to assess the driving state.

If the assessment device determines that the vehicle is reaching a critical driving state, for example, if wheels begin to slip, instantaneously prevailing wheel variables, in particular a wheel lateral force and/or a wheel circumferential force or a wheel torque, may be determined as the at least one cornering limit value.

The system may include a memory device to which the assessment device may transfer the at least one determined cornering limit value for storage so that the cornering limit value may be used for an electronic stability program.

According to another example embodiment of the invention, the assessment device may determine a cornering radius of the cornering path the vehicle is currently following. It may be possible to do this, for example, by determining a current yaw rate and a mean vehicle speed of the vehicle. The determination of the yaw rate of the vehicle and the cornering radius are discussed in greater detail below. As an alternative, the cornering radius may also be determined without previous calculation of the yaw rate from the vehicle speed, the tread of the vehicle and the speed difference, i.e., rotational speed difference, of the non-driven wheels.

Using the cornering radius determined, which may be a measure of the centrifugal force occurring during cornering and at a specific vehicle speed, and the coefficient of friction determined, which may be a measure of a maximum force transferable between a wheel or tires and the road surface, the assessment device may determine a maximum possible limit cornering acceleration and/or limit cornering speed as the at least one cornering limit value.

The system may include a memory device in this configuration as well for the same reason as above.

The driving state of the vehicle in cornering may be regulated in a simple manner if the assessment device outputs an actuating signal as well as if the system furthermore includes a servomechanism which may influence an operating state of the motor vehicle according to the actuating signal.

For this purpose, the assessment device may compare at least one current driving state value of the vehicle or at least one current wheel variable, i.e., a wheel-force component, a wheel torque or a wheel rotational speed with a corresponding stored cornering limit value and output the actuating signal as a function of the comparison result.

The servomechanism may change the engine output and/or a wheel braking pressure of at least one wheel according to the actuating signal. Possible changes of the engine output may include an adjustment of an engine throttle valve and/or an adjustment of the ignition point or a change in the fuel injection quantity. These may be implemented in conventional engines with components already provided.

The use of components already provided in a vehicle and accordingly the efficiency of the system according to the present invention may be enhanced by assigning the servomechanism and possibly also the assessment device to a device for controlling and/or regulating the driving response of a motor vehicle such as, for example, an ESP and/or antilock braking system and/or a TCS system. This assignment may also include the case when the servomechanism and/or assessment device are a part of the systems cited.

In a simple manner but with great accuracy, the wheel variables cited may be detected using a tire sensor device. Such sensor devices may make it possible to detect these wheel variables very close to the actual site of occurrence. As an alternative, a wheel bearing sensor device may also be suitable for implementing the system according to the present invention. In this case also, the site of detection of wheel variables may be so close to the site at which they occur that a great accuracy of the detection result may be ensured.

The features of the present invention described above may be achieved by a system for controlling and/or regulating the driving response of a motor vehicle having at least one tire and/or one wheel, a force sensor being affixed in the tire and/or to the wheel, to the wheel bearing in particular, a wheel variable being determined as a function of the output signals of the force sensor and this wheel variable being used to determine a cornering limit speed and/or a cornering limit acceleration and/or a corning limit torque and this cornering limit speed and/or this cornering limit acceleration and/or this cornering limit torque being taken into consideration in controlling and/or regulating the driving response.

The present invention may build on a conventional method in that the at least one wheel variable may be a wheel-force component of the wheel acting generally between the road surface and the wheel contact zone. The at least one cornering limit value may then be determined according to the at least one detected wheel variable of the wheel and thus may permit a precise determination of the at least one cornering limit value with a low sensor complexity. The accuracy of the at least one cornering limit value determined may increase with the number of wheels at which a wheel variable detection occurs.

In other respects, the features described in connection with the system according to the present invention may also be achieved by an example method according to the present invention so that reference may be made to the preceding description of the system for the supplemental description of the following improvements of the example method.

For precise determination of the cornering limit value, for example, by taking a vehicle speed into consideration, the processing step may include a determination of a wheel rotational speed.

As already described, the coefficient of friction utilized in each case may be determined accurately from the determined wheel-force components of a wheel, from the wheel lateral force in particular.

Moreover, the processing step may include a determination of a longitudinal acceleration of the vehicle, such as, for example, from the wheel circumferential force and/or the wheel rotational speed. This longitudinal acceleration may then be taken into consideration in determining the coefficient of friction utilized, making its determination possibly even more precise.

Similarly, at least one determined wheel-force component of at least one wheel on the inside of the curve and at least one wheel on the outside of the curve, or, for example, of each wheel, may be used to determine a dynamic axle load displacement in a simple manner, which may then also be taken into consideration in determining the coefficient of friction utilized in order to determine the coefficient of friction even more accurately. The wheel contact force may be suited for this purpose. The dynamic axle load displacement may also be determined in a manner other than from the wheel variables or from a wheel-force, for example, by an additional transverse acceleration sensor.

By analogy to the system, other possibilities may also exist for a method to determine the at least one cornering limit value. In an example embodiment of the method according to the present invention the determination of the at least one cornering limit value may include the following steps:

assessment of a driving state of the vehicle as critical or non-critical according to the at least one wheel-force component,

determination of at least one wheel variable, of a wheel lateral force and/or a wheel torque in particular, at which the vehicle attains a driving state assessed as critical, as the at least one cornering limit value, and

optional storage of the at least one cornering limit value.

The wheel torque mentioned may be determined in a simple manner from the wheel circumferential force and the wheel radius. The purpose of storing may include making the cornering limit value available for a subsequent driving state regulation.

In an alternative example method according to the present invention, the processing step may first include the following steps:

determination of a mean vehicle speed, such as, for example, from the determined wheel rotational speed of non-driven wheels,

determination of a cornering radius of the cornering path the vehicle is currently following, such as, for example, from a current yaw rate of the vehicle and the mean vehicle speed.

In this case, the step of determining the at least one cornering limit value may then include the following steps:

determination of a cornering limit acceleration and/or a cornering limit speed of the vehicle from the determined cornering radius and the determined coefficient of friction as the at least one cornering limit value, and

optional storage of the at least one cornering limit value.

A feature of the latter embodiment may be that the vehicle may not first need to reach a critical driving state for the determination of the at least one cornering limit value.

The two example methods cited for determining the at least one cornering limit value may also be used in combination with each other in order to mutually check the at least one cornering limit value determined and/or to improve the accuracy of the at least one cornering limit value determined. Moreover, the aforementioned determination of the cornering radius may also be used in the method cited above for storing wheel variables for a driving state that is becoming critical in order, for example, to attain limit cornering speeds and/or limit cornering accelerations from the limit wheel rotational speeds determined and from the cornering radius.

The traffic safety of a vehicle in which the example method according to the present invention is used may be increased by subsequent regulation of the driving state. This may include the following steps:

comparing at least one current driving state value or the at least one wheel-force component with a correspondingly stored cornering limit value,

influencing an operating state of the motor vehicle as a function of the comparison result.

The operating state of the motor vehicle may be influenced by a change of the engine output and/or a wheel braking pressure of at least one wheel. For the accuracy of the influencing of the operating state of the motor vehicle and to ensure an implementation of the method that is as simple as possible, the operating state of the motor vehicle may be influenced by a device for controlling and/or regulating the driving response of a motor vehicle such as, for example, an ESP and/or an ABS and/or a TCS system.

In the above description, driving state value refers to a value describing the driving state of the vehicle such as, for example, the vehicle speed and acceleration.

### BRIEF DESCRIPTION OF THE DRAWINGS

FIG. 1 shows a block diagram of an example system according to the present invention.

FIG. 2 shows a flow diagram of an example method according to the present invention.

FIG. 3 shows a flow diagram of an alternative example method according to the present invention.

FIG. 4 shows part of a tire equipped with a tire sidewall sensor.

FIG. 5 shows example waveforms of the tire sidewall sensor shown in FIG. 4.

### DETAILED DESCRIPTION

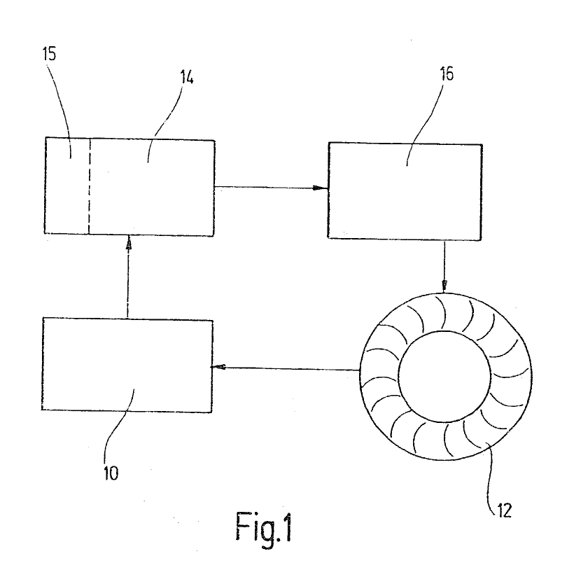

FIG. 1 shows a block diagram of an example system according to the present invention. A sensor device 10 is assigned to a wheel 12, wheel 12 shown being representative of the wheels of a vehicle. Sensor device 10 is connected to an assessment device 14 for processing signals of sensor device 10. Assessment device 14 is connected to a servomechanism 16. This servomechanism 16 is in turn assigned to wheel 12.

In the example shown here, sensor device 10 detects the wheel lateral force, the wheel contact force, the wheel circumferential force and the wheel rotational speed of wheel 12. The detection results derived from this are transferred to assessment device 14 for further processing. For example, the wheel-forces from a detected deformation of the tire may be determined in assessment device 14, for example by using a deformation-wheel-force characteristic stored in a memory unit.

In assessment device 14, it may be possible to determine the wheel variables describing the movement and traction state of the relevant wheel individually or in combination from the individual wheel-force components and from the wheel rotational speed. For example, the transferable driving torque may be determined from the wheel-forces at each wheel, the coefficient of friction utilized from the individual wheel lateral forces, the vehicle longitudinal acceleration from the wheel circumferential forces and/or the wheel rotational speeds, the vehicle speed from the wheel rotational speeds of non-driven wheels. A dynamic axle load displacement during cornering of the vehicle may be determined from the wheel contact forces, the knowledge of which in turn may improve the accuracy of the determination of the coefficient of friction.

Assessment device 14 checks if the vehicle is in a stable driving situation. If assessment device 14 establishes the occurrence of instabilities, for example because the vehicle or individual wheels begin to slip in a direction radial to a curve during cornering, assessment device 14 stores the currently detected wheel-force components and the vehicle speed as a limit wheel lateral force, limit wheel contact force, limit wheel circumferential force and as a limit cornering speed. One single such limit may be sufficient to implement the system or the example method according to the present invention. Similarly, limit forces may be converted into limit accelerations and stored as such.

The determination of the cornering path traveled from the coefficient of friction determined and the current cornering radius may offer another possibility for determining a limit cornering speed for the system or the example method according to the present invention. The determination of the current cornering radius is explained further below.

Assessment-device 14 subsequently compares one or more determined wheel variables with correspondingly stored limits and then outputs an actuating signal if the driving state threatens to become unstable.

This actuating signal may then be transferred to a servomechanism 16 so that a stabilizing influence may be brought to bear on the operating state of the vehicle, on wheel 12 in particular, as a function of the signal. Such an influence may, for example, result from an engine intervention, i.e., adjustment of the engine throttle valve and/or the ignition point and/or the fuel injection quantity and/or a braking intervention.

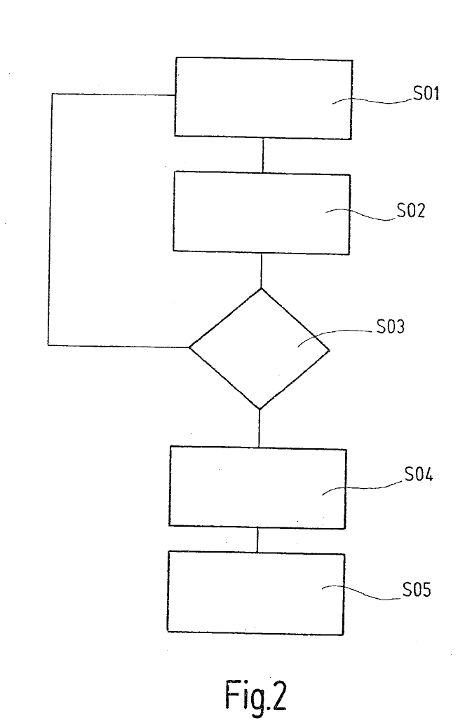

FIG. 2 shows a flow diagram of a first example embodiment of the method according to the present invention within the scope of the present invention, an assessment of the driving response of a vehicle while cornering being depicted. The system shown in FIG. 1 may be suitable in a particular manner for implementing the example method according to the present invention. First, the meaning of the individual steps will be indicated:

S01: Detection of a deformation and of a rotational speed of a tire by the sensor device.

S02: Determination of a lateral force, a circumferential force and a contact force of the tire on the road surface from the detected deformation.

S03: Comparison of the determined lateral force, circumferential force and contact force of the tire with one each of a limit lateral force value, limit circumferential force value and limit contact force value determined previously in an unstable driving state and stored; comparison of the wheel rotational speed with a limit wheel rotational speed determined previously in an unstable driving state and stored.

S04: Recognition of a critical driving state, generation of a suitable actuating signal.

S05: Influencing the driving state of the vehicle by braking and/or engine intervention.

The example method sequence shown in FIG. 2 may be followed in an identical or similar manner in a vehicle with rear-wheel drive or also with front-wheel drive. A deformation of a tire is detected in step S01. In addition, a wheel rotational speed or a wheel rotational velocity of the tire is determined in step S01.

In step S02, a wheel lateral force, a wheel circumferential force and a wheel contact force are determined from the deformations. This may be done, for example, using characteristics stored in the memory unit, the characteristics indicating the relationship between deformations and the relevant wheel-force components.

In step S03, the determined wheel-forces and the determined wheel rotational speed are compared with stored limits. The limits are wheel-forces and/or wheel rotational speeds that are stored in a memory device upon reaching an unstable driving state. If, for example, one of the limits is exceeded in step S03, then a critical driving state is recognized in step S04 and, proceeding from the recognized critical driving situation, a suitable actuating signal is determined. If, however, none of the limits is exceeded the sequence returns to step S01.

In step S05, the driving state of the vehicle is influenced according to the actuating signal from step S04.

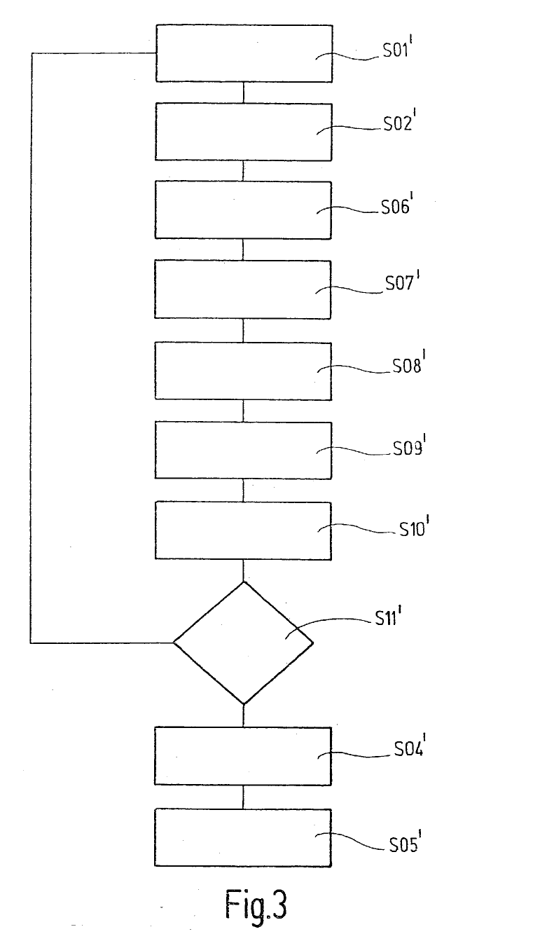

A flow chart of an alternative example method is shown in FIG. 3. In contrast to those of FIG. 2, the method steps are identified by apostrophized reference symbols. Identical reference symbols denote identical method steps. The specific meanings of the method steps are:

S01′: Detection of a deformation and of a rotational speed of a tire by the sensor device.

S02′: Determination of a lateral force, a circumferential force and a contact force of the tire on the road surface from the detected deformation.

S06′: Determination of a longitudinal acceleration of the vehicle from the detected wheel rotational speeds, such as, for example, by taking into consideration the wheel circumferential forces.

S07′: Determination of a dynamic axle load displacement from the detected wheel contact forces.

S08′: Determination of a coefficient of friction from the detected wheel-force components taking into consideration the longitudinal acceleration and the dynamic axle load displacement.

S09′: Determination of a cornering radius of the cornering path currently being followed.

S10′: Determination of a limit cornering acceleration and/or a limit cornering speed from the determined cornering radius and the determined coefficient of friction.

S11′: Comparison of a current cornering acceleration and/or a current vehicle speed with the limit cornering acceleration and/or the limit cornering speed.

S04′: Recognition of a critical driving state, generation of a suitable actuating signal.

S05′: Influencing the driving state of the vehicle by braking and/or engine intervention.

Steps S06′ and S07′ are not obligatory; however, the determination of a longitudinal acceleration of the vehicle and a dynamic axle load displacement of the vehicle during cornering contained in them may allow a more exact determination of the coefficient of friction in step S08′. Its determination may be based primarily on the determined wheel lateral force; however, additional wheel-force components acting between the road surface and the wheel contact zone as well as the values just stated may be taken into consideration.

In step S09′, the cornering radius of the cornering path that the vehicle is following is calculated from a yaw rate of the vehicle, for example. The yaw rate of a vehicle may be calculated, for example, from characteristic vehicle dimensions and the mean speed of non-driven wheels as follows:

a.) For rear-wheel drive vehicles:

$$ω = \frac{DV\_G}{\# SPURW \cdot cos ( δ )} \cdot \frac{1}{1 + c1 \cdot {VMNA}^{2}} ,$$

with cos(δ)=1−0.5·δ²

and

$$δ = DV\_G \cdot \frac{\# RADSTAND}{\# SPURW \cdot VMNA} = \frac{DV\_G}{VMNA} \cdot c2$$

b.) For front-wheel drive vehicles:

$$ω = \frac{DV\_G}{\# SPURW} \cdot \frac{1}{1 + c1 \cdot {VMNA}^{2}} .$$

C1 and C2 being constants, DV_G the differential speed between non-driven wheels, #RADSTAND the wheelbase of the vehicle, #SPURW the tread and VMNA the mean speed of non-driven wheels.

Cornering radius KURV_RAD of the cornering path currently being followed may then be determined from KURV_RAD=VMNA/ω.

In step S10′, a limit cornering acceleration and/or a limit cornering speed is calculated from the cornering radius thus determined, which may be a measure of the transverse acceleration occurring at a speed, and the coefficient of friction determined in step S08′, which may be a measure of the maximum force transferable between tires or wheel and the road.

In steps S11′, S04′ and S05′, the vehicle is regulated to the relevant limit cornering acceleration or limit cornering speed by comparing the actual cornering acceleration and/or the actual cornering speed of the vehicle with the limit cornering acceleration and/or the limit cornering speed and possibly by generating a suitable actuating signal combined with a corresponding influencing of the engine and/or the brakes.

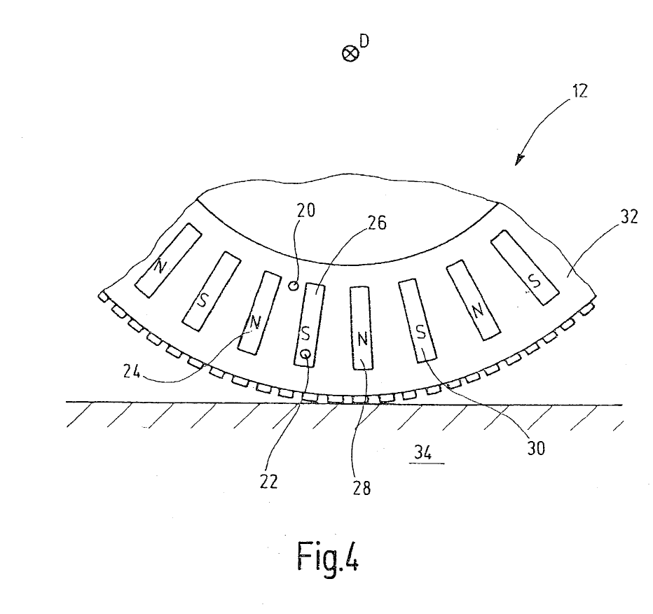

A section from a tire 32 mounted on wheel 12 having a tire/sidewall sensor device 20, 22, 24, 26, 28, 30 is shown in FIG. 4 with a view in the direction of axis of rotation D of tire 32. Tire/sidewall sensor device 20 includes two sensor devices 20, 22 which are affixed to the body at two different points in the direction of rotation. In addition, sensor devices 20, 22 each have a different radial spacing from the axis of rotation of wheel 12. The sidewall of tire 32 is provided with a plurality of magnetized surfaces proceeding in essentially a radial direction in relation to the wheel axis of rotation as sensors 24, 26, 28, 30 (strips) having field lines, for example proceeding in the circumferential direction. The magnetized surfaces have alternating magnetic polarity.

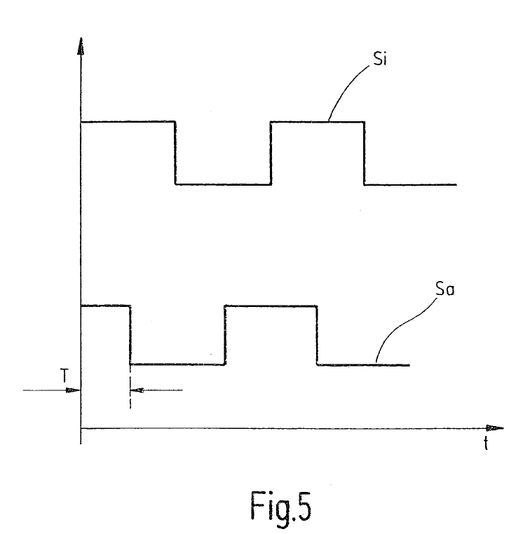

FIG. 5 shows the waveforms of signal Si of inner sensor device 20, i.e., arranged closer to axis of rotation D of wheel 12, according to FIG. 4 and of signal Sa of outer sensor device 22, i.e., arranged further from axis of rotation D of wheel 12, according to FIG. 4. A rotation of tire 32 is recognized by the changing polarity of measurement signals Si and Sa. From the rolling circumference and the change over time of signals Si and Sa, it may be possible, for example, to calculate the wheel rotational speed. Using phase shifts T between the signals, it may be possible to determine deformations, for example torsions, of tire 32 and thus directly measure wheel-forces.

The above description of the example embodiments according to the present invention is only intended to illustrate and not limit the invention. Various changes and modifications are possible within the scope of the invention without departing from the scope of the invention and its equivalents.

What is claimed is:

1. A system for monitoring the cornering behavior of a motor vehicle having at least one wheel (12), comprising
at least one sensor device (10) assigned to a wheel (12) which detects at least one wheel variable of the wheel (12) during cornering of the vehicle and outputs a signal (Si, Sa) representing the at least one wheel variable; and
an assessment device (14) which processes the signal (Si, Sa), the assessment device (14) determining at least one cornering limit value value according to the result of the processing,
wherein the sensor device (10) is a wheel-force sensor device (10) which detects at least one wheel-force component of the wheel (12) acting essentially between the road surface and the wheel contact zone.

2. The system according to claim 1, wherein the assessment device (14) also determines a wheel rotational speed of the relevant wheel (12) from the at least one sensor signal (Si, Sa).

3. The system according to claim 1 or 2, wherein the assessment device (14) determines the coefficient of friction utilized in each case from at least one wheel-force component determined from the sensor signal (Si, Sa), preferably from the wheel lateral force.

4. The system according to one of the preceding claims, wherein the assessment device (14) determines a longitudinal acceleration of the vehicle, preferably from a wheel circumferential force and/or the wheel rotational speed of the wheel, preferably of all wheels.

5. The system according to one of the preceding claims, wherein the assessment device (14) takes the longitudinal acceleration of the vehicle into consideration in determining the coefficient of friction utilized.

6. The system according to one of the preceding claims, wherein the assessment device (14) determines a dynamic axle load displacement of the vehicle during cornering preferably from the wheel contact force of at least one wheel on the inside of the curve and at least one wheel on the outside of the curve, preferably of each wheel.

7. The system according to one of the preceding claims, wherein the assessment device (14) takes the dynamic axle load displacement of the vehicle into consideration in determining the coefficient of friction utilized.

8. The system according to one of the preceding claims, wherein
the assessment device (14) assesses a driving state of the vehicle as critical or non-critical according to at least one determined wheel-force component,
it moreover determines at least one current wheel variable, wheel lateral force and/or wheel circumferential force or wheel torque in particular, at which the vehicle attains a driving state assessed as critical, as the at least one cornering limit value, and
it preferably transfers the at least one cornering limit value to a memory device (15) for storage.

9. The system according to one of the preceding claims, wherein the assessment device (14) determines a cornering radius of the cornering path the vehicle is currently following, preferably from a current yaw rate of the vehicle and the mean speed of non-driven wheels of the vehicle.

10. The system according to one of the preceding claims, wherein the assessment device (14) determines a limit cornering acceleration and/or a limit cornering speed of the vehicle as the at least one cornering limit value from the determined cornering radius and the determined coefficient of friction, and
it preferably transfers the at least one cornering limit value to a memory device for storage.

11. The system according to one of the preceding claims, wherein
the assessment device (14) compares at least one current driving state value of the vehicle or at least one current wheel variable with a corresponding stored cornering limit value and outputs an actuating signal as a function of the comparison result, and
the system moreover includes a servomechanism (16) which influences an operating state of the motor vehicle according to the actuating signal.

12. The system according to one of the preceding claims, wherein the servomechanism (16) changes the engine output and/or a wheel braking pressure of at least one wheel (12) according to the actuating signal.

13. The system according to one of the preceding claims, wherein the servomechanism (16) and possibly also the assessment device (14) is/are assigned to a device for controlling and/or regulating the driving response of a motor vehicle such as, for example, an ESP and/or an ABS and/or a TCS system.

14. The system according to one of the preceding claims, wherein the sensor device (10) is a tire sensor device (20, 22, 24, 26, 28, 30) and/or a wheel bearing sensor device.

15. A system for controlling and/or regulating the driving response of a motor vehicle having at least one tire (32) and/or one wheel (12), a force sensor (20, 22) being mounted in the tire (32) and/or on the wheel (32), on the wheel bearing in particular, and a wheel variable being determined as a function of the output signals of the force sensor (20, 22), and this wheel variable being used to determine a cornering limit speed and/or a cornering limit acceleration and/or a cornering limit torque, and this cornering limit speed and/or this cornering limit acceleration and/or this cornering limit torque being taken into consideration in controlling and/or regulating the driving response.

16. A method of monitoring the cornering behavior of a motor vehicle having at least one wheel (12) comprising the steps:
detection of at least one wheel variable of a wheel during cornering of the vehicle (S01, S02; S01′, S02′);
processing of the at least one wheel variable of the wheel (S03; S06′ to S09′); and
determination of at least one cornering limit value according to the result of the processing (S03; S10′),
wherein the at least one wheel variable is a wheel-force component of the wheel acting essentially between the road surface and the wheel contact zone.

17. The method according to claim 16, wherein the detection step includes a determination of a wheel rotational speed (S01; S01′).

18. The method according to claim 16 or 17, wherein the processing step includes a determination of a coefficient of friction utilized, in particular from a wheel lateral force of the wheel, preferably of each wheel (S08′).

19. The method according to one of claims 16 to 18, wherein the processing step includes a determination of a longitudinal acceleration of the vehicle, preferably from the wheel circumferential force and/or the wheel rotational speed of the wheel, in particular of each wheel (S06′).

20. The method according to one of claims 16 to 19, wherein a longitudinal acceleration of the vehicle, preferably the longitudinal acceleration determined from a wheel variable, is taken into consideration in determining the coefficient of friction utilized (S08′).

21. The method according to one of claims 16 to 20, wherein the processing step includes a determination of a dynamic axle load displacement of the vehicle, preferably from the wheel contact force of the wheel, in particular of each wheel (S07′)

22. The method according to one of claims 16 to 21, wherein the dynamic axle load displacement of the vehicle is taken into consideration in determining the coefficient of friction utilized (S08′).

23. The method according to one of claims 16 to 21, wherein the step of determining (S03) the at least one cornering limit value includes the following steps:
assessment of a driving state of the vehicle as critical or non-critical according to the at least one wheel-force component (S03),
determination of at least one wheel variable, of a wheel lateral force and/or a wheel circumferential force or a wheel torque in particular, at which the vehicle attains a driving state assessed as critical, as the at least one cornering limit value, and
preferably storage of the at least one cornering limit value.

24. The method according to one of claims 16 to 23, wherein the processing step includes the following steps:
determination of a mean vehicle speed, preferably from the determined wheel rotational speed,
determination of a cornering radius of the cornering path the vehicle is currently following, preferably from a current yaw rate and the mean speed of non-driven wheels of the vehicle (S09′).

25. The method according to one of claims 16 to 24, wherein the step of determining the at least one cornering limit value includes the following steps:
determination of a cornering limit acceleration and/or a cornering limit speed of the vehicle from the determined cornering radius and the determined coefficient of friction as the at least one cornering limit value (S10′), and
preferably storage of the at least one cornering limit value.

26. The method according to one of claims 16 to 25, wherein it includes the following steps:
comparing at least one current driving state value or the at least one wheel-force component with a correspondingly stored cornering limit value (S03; S11′),
influencing an operating state of the motor vehicle as a function of the comparison result (S04, S05; S04′, S05′).

27. The method according to one of claims 16 to 26, wherein the influencing of an operating state of the motor vehicle includes a change of the engine output and/or of a wheel braking pressure of at least one wheel (12).

28. The method according to one of claims 16 to 27, wherein the influencing of an operating state of the motor vehicle is performed by a device for controlling and/or regulating the driving response of a motor vehicle such as, for example, an ESP and/or an ABS and/or a TCS system.
